(19) United States
(12) Patent Application Publication
(10) Pub. No.: US 2022/0215109 A1
(43) Pub. Date: Jul. 7, 2022

(54) NEW INTERNET VIRTUAL DATA CENTER SYSTEM AND METHOD FOR CONSTRUCTING THE SAME

(71) Applicant: TONGJI UNIVERSITY, Shanghai (CN)

(72) Inventors: Changjun JIANG, Shanghai (CN); Zhaohui ZHANG, Shanghai (CN); Pengwei WANG, Shanghai (CN); Zhijun DING, Shanghai (CN); Jian YU, Shanghai (CN); Chungang YAN, Shanghai (CN); Yaying ZHANG, Shanghai (CN)

(73) Assignee: TONGJI UNIVERSITY, Shanghai (CN)

(21) Appl. No.: 17/437,049

(22) PCT Filed: Dec. 16, 2019
(86) PCT No.: PCT/CN2019/125548

§ 371 Date: Sep. 8, 2021

(30) Foreign Application Priority Data
Sep. 27, 2019 (CN) 2019109266982

(51) Int. Cl. G06F 21/62

(52) U.S. Cl. CPC G06F 21/6218

(57) ABSTRACT

The present disclosure provides a new Internet virtual data center system and a method for constructing the same. The new Internet virtual data center system includes: an Internet data explorer to sample and estimate Internet data to generate a data resource distribution map, the data resource distribution map reflects attribute information of Internet data; an Internet virtual resource library to store data resource distribution map and sample data collected by the Internet data explorer; a data resource distribution map management module to manage data resource distribution map; and a data resource guidance service module to generate and provide guidance service for data collection and mining of a data demander according to data resource distribution map. The present disclosure overcomes the blindness and disorder of the big data collection and development of the existing data centers, and avoids waste of resources and energy.

### BACKGROUND

### Field of Disclosure

The present disclosure belongs to the technical field of computer big data, in particular, to a new Internet virtual data center system and a method for constructing the same.

### Description of Related Arts

The overall structure of the traditional data center system includes an infrastructure layer, an information resource layer, an application support layer, an application layer, and a support system. The traditional data center system has a centralized or distributed storage/access data architecture, which realizes the linkage of data resource management and timely monitoring, summarization and analysis of information. The purpose of building a data center is to safely and stably deliver user's content or application services to users at a faster speed. Cloud computing data centers are not hosting customers' equipment, but computing power and IT availability. Data is transmitted in the cloud, and the cloud computing data center allocates the necessary computing power for it, and manages the background of the entire infrastructure. Virtual Data Center (VDC) is a new form of data center that applies cloud computing concepts. VDC can abstractly integrate physical resources through virtualization technology, dynamically allocate and schedule resources, realize the automatic deployment of data centers, and will greatly reduce the operating costs of data centers. Existing data centers have control over the data. Due to the unified storage and management of the large amount of collected Internet data, it is difficult for data centers to maintain the data, resulting in a lot of data redundancy and daily energy consumption.

In the context of big data, data sources are very rich and data types are diverse, and the amount of data stored and analyzed is huge and scattered. For the collection of data sources, Uniform Resource Locator (URL) information can be collected through a combination of a universal crawler and a website map or a web robot to establish a URL list. The data collection of the internal database needs to call the Application Programming Interface (API) to realize the collection of the internal database according to the method in the Database (DB) API protocol. For static Web pages, complete html data is required to analyze the Document Object Model (DOM) tree through an HTML parsing tool to find the collected data, such as ScrapySharp. Many contents of dynamic Web pages are dynamically generated through javascript. These dynamic Web data cannot statically obtain the required data. For dynamic Web pages, the browser engine is often used to load the entire page, and then a static page collection method is used after obtaining the complete page. The information sources of existing Internet data centers collect and crawl large amounts of Internet data, and organize and process the data to provide application support to customers. Due to the high complexity and discrete of Internet information, large-scale crawling affects the quality of network communication and increases energy consumption, the collected information contains a large amount of redundant information and has low information value, and the purpose of the information search is not strong.

In the context of massive data, the data cannot be crawled and stored completely. It is necessary to reduce the difficulty of data mining by analyzing the distribution of data. A small portion of data from an Internet site can be collected to analyze and estimate the value density and distribution of the data size of the entire site. The existing original sample distribution methods based on small sample data analysis include: decision tree analysis in classification, univariate and multiple linear regression analysis, logistic regression analysis, polynomial regression, stepwise regression, ridge regression, lasso regression, etc. in regression analysis; sample cluster analysis, index cluster analysis, systematic clustering, stepwise clustering, etc. in cluster analysis; Fisher and BAYES discriminant analysis methods in discriminant analysis, etc. Methods based on large sample data analysis include: feedforward neural network models represented by functional networks and perceptrons in neural networks, feedback neural network models represented by Hopfield discrete models and continuous models, and clustering self-organizing mapping method represented by ART models, etc.

In summary, the existing Internet data center technology has the following technical problems:

First, as features such as explosive growth and diversification trend of big data become more and more obvious, the existing methods essentially lack the consideration of the data as a whole, do not perceive the status of data resources in advance, and can not describe and measure features such as the overall distribution, data size, and composition of Internet big data resources.

Second, the massive collection and storage of Internet data by traditional data centers has resulted in a large amount of inefficient or even invalid data collection and processing, wasting a lot of storage and transmission resources.

Third, to cope with data growth, new data centers are constructed in a large scale and existing data centers are expanded, the number and scale of global data centers are growing rapidly, disorderly and repetitive construction is becoming increasingly severe, and a prominent problem is the huge energy consumption of data centers.

Therefore, it is necessary to provide a new Internet virtual data center system and a method for constructing the same to solve the problems that the existing big data center mainly adopts full data collection, analysis, processing and other methods, resulting in blindness in data acquisition and disorder of resource utilization, which greatly wastes various computing resources, storage resources and energy.

### SUMMARY

The present disclosure provides a new Internet virtual data center system and a method for constructing the same, to solve the problems that the existing big data center mainly adopts full data collection, analysis, processing and other methods, resulting in blindness in data acquisition and disorder of resource utilization, which greatly wastes various computing resources, storage resources and energy.

The present disclosure provides a new Internet virtual data center system, which includes: an Internet data explorer to sample and estimate Internet data to generate a data resource distribution map, the data resource distribution map reflects attribute information of Internet data; an Internet virtual resource library to store the data resource distribution map and sample data collected by the Internet data explorer; a data resource distribution map management module to manage the data resource distribution map; and a data resource guidance service module to generate and provide guidance service for data collection and mining of a data demander according to the data resource distribution map.

In an embodiment of the present disclosure, the new Internet virtual data center system further includes: a data protocol generation and management module to generate a unified data access protocol file based on a data access protocol and a network site map provided by a data provider, and manage the data access protocol file; a data security management module to perform data security management of a virtual data resource in the Internet virtual resource library.

In an embodiment of the present disclosure, the Internet data explorer includes: a data sampling guide unit to generate data sampling guidance information according to a data access protocol file provided by a data provider, to realize sampling guide for Internet Web data and/or sampling guide for an application programming interface of an internal database, a data structure of the data sampling guidance information is a data sampling guide tree and/or data sampling guide table, the data sampling guide tree is guide information for sampling the Internet data, the data sampling guide table accesses the internal database of a network site through the application programming interface; a data sampling estimation unit to sample and grab Internet data to the Internet virtual resource library according to the data sampling guide tree and/or data sampling guide table, perform Internet Web data sampling estimation and/or internal database application program programming interface sampling estimation; the attribute information includes a data category, a data modality, a data amount, a data component, and a data distribution; and a data resource distribution map generation unit to generate the data resource distribution map according to the attribute information of the Internet Web data and access restriction in the data sampling guide tree.

In an embodiment of the present disclosure, the data resource distribution map includes initialization layer nodes and an expansion layer nodes, and the initialization layer nodes and the expansion layer nodes form a tree structure, the initialization layer nodes include zeroth layer nodes, first layer nodes, and second layer nodes, the expansion layer nodes include third layer nodes, the zeroth layer nodes are root nodes, and description items of the zeroth layer nodes record a data classification method, a data classification number, an access restriction, a first category pointer, a second category pointer . . . , an nth category pointer, and an extended item, the data classification method is configured to record a data classification model or method; the category pointer is configured to point to a category node, and the extended item is configured to expand information; the first layer nodes are classification nodes of field, description items of each of the first layer nodes record a number of a data modality, a limit command, a text pointer, an image pointer, a video pointer, an audio pointer, other pointers, and an extension item, the data modality number refers to the classification number of data modality, including text, image, video, audio, and others; the text pointer, the image pointer, the video pointer, the audio pointer, and the other pointers are link pointers that record to a child node, and the child node is a node of a data modality; the second layer nodes are data modal classification nodes, and description items of each of the second layer nodes record a number of network sites, a limit command, a first site pointer, a second site pointer, . . . , an mth site pointer, and an extension item, the number of network sites refers to a total number of network sites in An extrusion data modality and represents a number of child nodes of each of the second layer nodes, and the site pointer is configured to record each child node; and the third layer nodes are data nodes, and description items of each of the third layer nodes record a data location, a limit command, a data amount, a data component, a data distribution, a data timing, an access command and parameter, a return data format, and an extension item, the data location is configured to record a site location of a data source, the limit command is a limit access description for accessing the data source, the data amount is the amount of data from the data source provided by a data provider, the data component represents a constituent element of data, the data distribution represents a basic characteristic and distribution of Internet data, the data timing represents whether there is a time series relationship between the Internet data, the access command and parameter record a command and a parameter for accessing the data source, and the return data format refers to a format of acquired data.

The data resource distribution map management module is configured to store, access, and update the data resource distribution map, the data resource distribution map is stored using a relational or non-relational database; the data resource distribution map is accessed according to a tree structure; and the data resource distribution map is dynamically updated.

The present disclosure further provides a method for constructing a new Internet virtual data center system. The method includes: constructing an Internet data explorer based on a data access protocol and Internet data provided by a data provider, the Internet data explorer is configured to sample and estimate the Internet data to generate a data resource distribution map; constructing an Internet virtual resource library according to Internet data explored by the Internet data explorer; the Internet virtual resource library is configured to store the data resource distribution map and sample data collected by the Internet data explorer; managing the Internet data explored by the Internet data explorer and the data resource distribution map; and generating and providing guidance service for data collection and mining of a data center and/or a data demander according to the data resource distribution map.

In an embodiment of the present disclosure, the method further includes: generating a unified data access protocol file based on a data access protocol and a network site map provided by a data provider, and managing the data access protocol file; and performing data security management of a virtual data resource in the Internet virtual resource library.

In an embodiment of the present disclosure, said constructing of the Internet data explorer based on the data access protocol and Internet data provided by the data provider includes: S11: generating data sampling guidance information according to a data access protocol file provided by a data provider, to realize sampling guide for Internet Web data and/or sampling guide for an application programming interface of an internal database, a data structure of the data sampling guidance information is a data sampling guide tree and/or data sampling guide table, the data sampling guide tree is guide information for sampling the Internet Web data, the data sampling guide table accesses the internal database of a network site through the application programming interface; S12: grabbing Internet data to the Internet virtual resource library according to the data sampling guide tree and/or data sampling guide table, sampling and estimating the Internet Web data and/or the application programming interface of the internal database, the attribute information includes a data category, a data modality, a data amount, a data composition and/or data distribution; and S13: generating the data resource distribution map according to the attribute information of the Internet Web data and access restriction in the data sampling guide tree.

In an embodiment of the present disclosure, a guide process of the sampling guide for the Internet Web data includes the following steps: S111: receiving an uniform resource locator and grabbing a crawler protocol file in a root directory of the network site; S112: extracting a restriction item and a site map file in the crawler protocol file; S113: generating the data sampling guide tree for extractable data and a resource list of restricted access to the Internet data; writing an allowed access item and a restricted access item to a site node attribute, and a prohibited access item to the resource list of restricted access to the Internet data; S114: breadth-first searching the data sampling guide tree, randomly extracting several linked pages in each network site; S115: analyzing the uniform resource locator in the linked page, searching for the uniform resource locator in the resource list of restricted access to the Internet data, and omitting it if the uniform resource locator exists in the resource list of restricted access to the Internet data; performing the next step if the uniform resource locator does not exist in the resource list of restricted access to the Internet data; S116: analyzing page content and a file name suffix, initially separating the data modality, and writing a modal attribute of a tree leaf node of the data sampling guide tree; S117: analyzing a time attribute of the page content and writing a time series related attribute of the tree leaf node of the data sampling guide tree; S118: repeating S114 to S117 until the end of access to the data sampling guide tree, and writing an attribute of restricted access into a restricted attribute of the tree leaf node of the data sampling guide tree.

In an embodiment of the present disclosure, a guide process of the sampling guide for the application programming interface of the internal database includes: determining whether an access configuration file of the application programming interface of the internal database of a designated network site can be grabbed within the designated network site, if the access configuration file can not be grabbed within the designated network site, instructing an operator to manually generate the access configuration file of the application programming interface of the internal database, if the access configuration file can be grabbed within the designated network site, performing the next step; and analyzing the access configuration file of the application programming interface of the internal database, initially separating the data modality, and filling a data sampling guide information table of the internal database.

In an embodiment of the present disclosure, an estimation process of the sampling and estimation of the Internet Web data includes the following steps: S121: reading the data sampling guide tree of the network site; S122: grabbing a page according to a leaf node, and separating a number of effective links according to a uniform resource locator template of the leaf node; S123: determining whether site data is related to time series, if the site data is related to the time series, executing S124: setting a grabbing time interval, grabbing data in the grabbing time interval, and writing the data to the Internet virtual resource library to count a number of pages; S125: estimating a data distribution of various modal data within the time interval by using an interval estimation method; S126: classifying the pages by using an existing classification model, estimating a data distribution of various site data within the time interval by using the interval estimation method, then turning to S130; if the site data is not related to the time series, executing S127: setting a randomly grabbed page location, grabbing data in a random location, writing the data to the Internet virtual resource library, and counting a number of pages; S128: estimating a data distribution of various modal data by using a point estimation method; S129: classifying the pages by using an existing classification model, estimating various data distributions by using a point estimation method, then turning to S130; S130: calculating the total data of a site according to a total number of site links, a data modal distribution, and a classified data distribution, and the sampling and estimation ends.

In an embodiment of the present disclosure, an estimation process of the sampling and estimation for the application programming interface of the internal database includes the following steps: S121′: reading the data sampling guide table; S122′: analyzing a data item of the data sampling guide table; S123′: determining whether site data is related to time series, if the site data is related to the time series, executing S124′: setting several grabbing time intervals, grabbing site data in the grabbing time interval, writing the data to the Internet virtual resource library, and counting a number of records in each time interval; S125′: setting a time jump step, and estimating a data distribution in the time interval; S126′: classifying data in the time interval by using an existing classification model, recording the data to a first layer node item of the data resource distribution map, and going to S130′; if the site data is not related to the time series, executing S127′: setting several record numbers of randomly grabbed site data, grabbing the site data, writing the site data to the Internet virtual resource library, and counting a number of records; S128′: setting a record jump step, and estimating a site data distribution; S129′: classifying data by using an existing classification model, recording the data to a first layer node item of the data resource distribution map; and S130′: calculating the total data of the network site according to a site data modal distribution and classified data distribution.

In an embodiment of the present disclosure, said generating of the data resource distribution map according to the attribute information of the Internet Web data and access restriction in the data sampling guide tree includes: initializing the data resource distribution map, which includes: constructing root nodes, constructing a first layer nodes, and constructing a second layer nodes; extending a third layer nodes according to data classification and the data modality sampled and estimated by data, and writing an uniform resource locator of a data location into a position description item corresponding to the extended third layer nodes; analyzing an amount of data at the location and a total amount of accumulated data, a data component, a data distribution, a data timing, an access restriction, etc., writing a corresponding description item to analyze the amount of data at the location, and writing into a description item of the total amount of data corresponding to the third layer nodes; accumulating the total amount of data and writing into the description item of the total amount of data; analyzing the data component at the location, and writing the data component into a data component description item of the third layer nodes; analyzing a characteristic of data distribution at the location, and writing the characteristic of data distribution into a data distribution description item of the third layer nodes; analyzing the data timing at the location, and writing a characteristic of data timing into a data timing description item of the third layer nodes; writing the access restriction of the data location into an access restriction description item corresponding to the third layer nodes according to the data sampling guide tree; and determining whether the data exploration is cut off; if the data exploration is cut off, writing the filled data resource distribution map to the Internet virtual resource library, and publishing an access interface to an outside, the step of generating the data resource distribution map ends; if the data exploration is not cut off, extending the third layer nodes according to the data classification and the data modality sampled and estimated by the data, and writing the uniform resource locator of the data location into the position description item corresponding to the extended third layer nodes; analyzing an amount of data at the location and a total amount of accumulated data, a data component, a data distribution, a data timing, an access restriction, etc., writing a corresponding description item to analyze the amount of data at the location, and writing into a corresponding description item.

In an embodiment of the present disclosure, said managing of the Internet data explored by the Internet data explorer and the data resource distribution map includes: storing, accessing, and updating the data resource distribution map.

In an embodiment of the present disclosure, said updating of the data resource distribution map includes: configuring an updating strategy; calling a data sampling guide module to update a data sampling guide tree/guide table and comparing change parts of a data source; for the change parts of the data source, calling a data sampling and estimation unit in the new Internet virtual data center system to perform sampling and estimation, updating an original data node of the data resource distribution map, and shortening an update period of the data node at the same time; for the change parts of the data source, randomly selecting the data source, and calling the data sampling and estimation unit to perform sampling and estimation, to determine whether the data source changes; if the data source changes, updating the data resource distribution map; if the data source does not change, extending the update period of the data node; determining whether the update is cut off, if the update is cut off, writing the updated data resource distribution map to the Internet virtual resource library; if the update is not cut off, calling the data sampling guide module to update the data sampling guide tree/guide table and comparing the change parts of the data source.

As described above, the new Internet virtual data center system and the method for constructing the same of the present disclosure have the following beneficial effects:

The new Internet virtual data center system and the method for constructing the same of the present disclosure propose the idea and technology of Internet big data exploration, realize the virtualization of Internet big data resources, construct the big data resource distribution map, and provide services such as data navigation for the data center.

Different from the traditional and existing data centers that use full data collection, analysis, processing and other methods, the method for constructing the new Internet virtual data center system adopts the Internet big data exploration idea, and turns mass collection into pre-quantization exploration. The key of the method is to construct an Internet data explorer and a data resource distribution map, and provide the distribution condition of Internet data to traditional and existing data centers and other data demanders. The new Internet virtual data center system and the method for constructing the same overcome the blindness and disorder of the big data collection and development of the traditional and existing data centers, and avoid a lot of waste of resources and energy.

### BRIEF DESCRIPTION OF THE DRAWINGS

FIG. 1A shows a schematic view of a new Internet virtual data center system according to an embodiment of the present disclosure.

FIG. 1B shows a schematic view of the principle of an Internet data explorer in the new Internet virtual data center system according to the present disclosure.

FIG. 2A shows a schematic view of a data sampling guide tree according to the present disclosure.

FIG. 2B shows a schematic view of a data resource distribution map according to the present disclosure.

FIG. 3A shows a schematic flow chart of a method for constructing a new Internet virtual data center system according to an embodiment of the present disclosure.

FIG. 3B shows a schematic flow chart of S1 in the method for constructing a new Internet virtual data center system according to the present disclosure.

FIG. 3C shows a schematic flow chart of the sampling guide of Internet Web data according to the present disclosure.

FIG. 3D shows a schematic flow chart of the estimation process of sampling and estimation of the Internet Web data according to the present disclosure.

FIG. 3E shows a schematic flow chart of the estimation process of the sampling and estimation for the application programming interface of the internal database according to the present disclosure.

FIG. 3F shows a schematic flow chart of S13 in the method for constructing a new Internet virtual data center system according to the present disclosure.

FIG. 3G shows a schematic flow chart of updating the data resource distribution map according to the present disclosure.

### DESCRIPTION OF REFERENCE NUMERALS

1 New Internet virtual data center system
11 Data protocol generation and management module
12 Internet data explorer
13 Internet virtual resource library
14 Data resource distribution map management module
15 Data resource guidance service module
16 Data security management module
121 Data sampling guide unit
122 Data sampling and estimation unit
123 Data resource distribution map generation unit
S11 to S16 Steps

### DETAILED DESCRIPTION OF THE PREFERRED EMBODIMENTS

The embodiments of the present disclosure will be described below through exemplary embodiments. Those skilled in the art can easily understand other advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure. It needs to be stated that the following embodiments and the features in the embodiments can be combined with one another under the situation of no conflict.

It needs to be stated that the drawings provided in the following embodiments are just used for schematically describing the basic concept of the present disclosure, thus only illustrating components only related to the present disclosure and are not drawn according to the numbers, shapes and sizes of components during actual implementation, the configuration, number and scale of each component during actual implementation thereof may be freely changed, and the component layout configuration thereof may be more complex.

### Embodiment 1

This embodiment provides a new Internet virtual data center system, including: a data protocol generation and management module to generate a unified data access protocol file based on a data access protocol and a website map provided by a data provider, and manage the data access protocol file; an Internet data explorer to sample and estimate Internet data to generate a data resource distribution map, the data resource distribution map reflects attribute information of Internet data; an Internet virtual resource library to store the data resource distribution map and sample data collected by the Internet data explorer; a data resource distribution map management module to manage the data resource distribution map; and a data resource guidance service module to generate and provide guidance service for data collection and mining of a data demander according to the data resource distribution map.

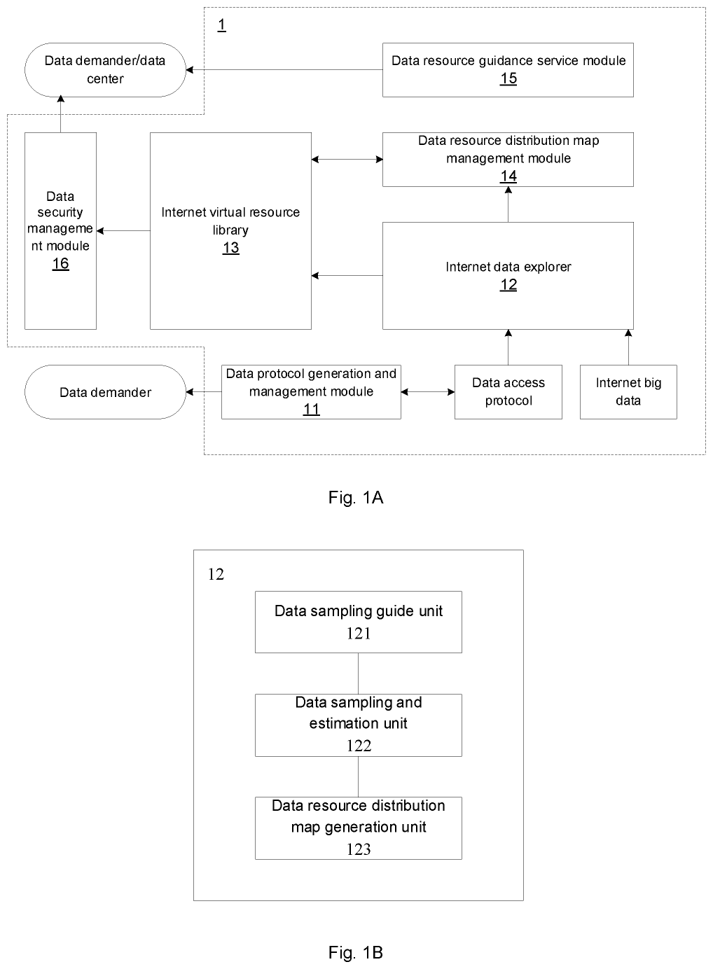

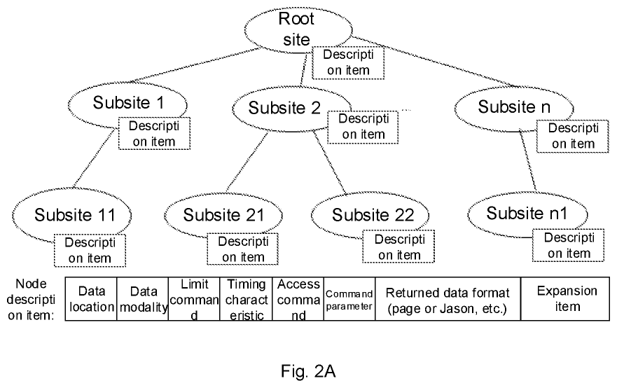

The new Internet virtual data center system in this embodiment will be described in detail below with reference to the drawings. The new Internet virtual data center system in this embodiment is applied between the data provider and the data demander. FIG. 1A shows a schematic view of a new Internet virtual data center system according to an embodiment of the present disclosure. As shown in FIG. 1A, the new Internet virtual data center system 1 includes a data protocol generation and management module 11, an Internet data explorer 12, an Internet virtual resource library 13, a data resource distribution map management module 14, a data resource guidance service module 15, and a data security management module 16.

The data protocol generation and management module 11 generates a unified data access protocol file based on a data access protocol and a network site map provided by a data provider, and manages the data access protocol file. In this embodiment, the data access protocol file includes a Web data access protocol, an Internet internal database access protocol, etc. The management of the data access protocol file includes issuing and updating the protocol.

The Internet data explorer 12 coupled with the data protocol generation and management module 11 samples and estimates the Internet data to generate a data resource distribution map. The data resource distribution map reflects attribute information of Internet data, and is the key data structure component of the new Internet virtual data center system. The attribute information of the Internet data includes data size value density information and overall distribution information of network sites, and the like. The overall distribution information of the Internet data includes data location, data amount, data characteristics and other information, and is a guide information table for large-scale data collection.

FIG. 1B shows a schematic view of the principle of an Internet data explorer. As shown in FIG. 1B, the Internet data explorer 12 specifically includes a data sampling guide unit 121, a data sampling and estimation unit 122, and a data resource distribution map generation unit 123.

The data sampling guide unit 121 generates data sampling guidance information according to a data access protocol file and Internet big data provided by a data provider, to realize sampling guide for Internet Web data and/or sampling guide for an application programming interface of an internal database. The data structure of the data sampling guidance information is represented as a data sampling guide tree and/or data sampling guide table, the sampling guide for Internet Web data means reading data crawling protocol files and site map files on the Internet, and reading some data according to a certain strategy to generate a data sampling guide tree. The data sampling guide tree records accessible data site resources and their access rights. The sampling guide for the application programming interface of the internal database means reading the standard access file provided by the data provider for access methods and access restrictions, and generating a data sampling guide tree. If no standard access restriction file is provided, the standard access file is manually configured, and then the data sampling guide tree is generated.

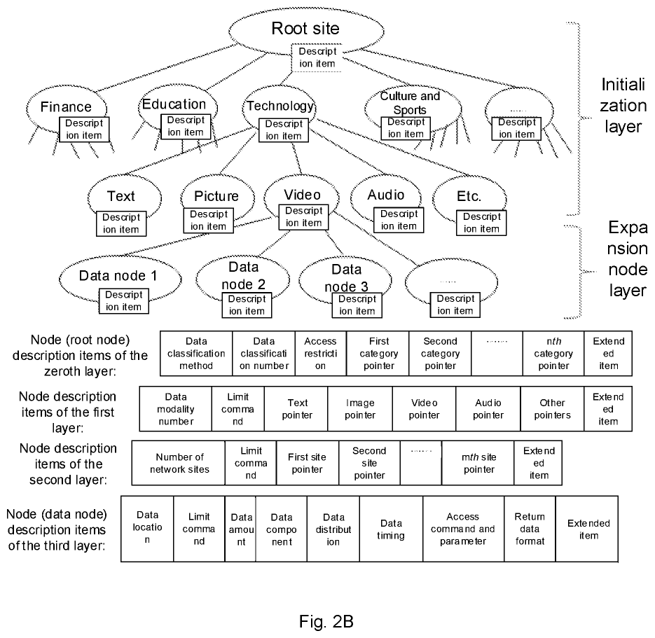

In this embodiment, the data sampling guide tree is guide information for sampling the Internet Web data. FIG. 2A shows a schematic view of the data sampling guide tree. As shown in FIG. 2A, the data sampling guide tree has a tree structure. The root node is the root directory node of the website, and the child node is the subdirectory node of the subsite. The description items of each node include a data location (site location where the data is located), a data modality (text, image, video, audio, etc.), a data explorer name, a data access restriction command, a data timing characteristic, an access command, a command parameter, a returned data format (page or Jason and other data formats), and an extended item (for the extended description of other web-based data).

The data sampling guide table is a data sampling guide information table that accesses the internal database of a network site through the application programming interface. Referring to Table 1 for the specific structure of the data sampling guide information table. As shown in Table 1, the data sampling guide information table mainly includes a data location (site location where the data is located), a data modality, a data explorer name, an access prohibited/restricted item, an API call function table (including parameters and return values) description, a data timing, a data distribution, whether data is online, and an extended item.

TABLE 1
Data sampling guide information table

| | | | | | | | | |
|---|---|---|---|---|---|---|---|---|
| Resource | Data | Data | Access | API call | Data | Data | Whether | Extended |
| location | modality | explorer | prohibited/ | function table | timing | distribution | data is | item |
| | | name | restricted | (including | | | online | |
| | | | item | parameters and | | | | |
| | | | | return value) | | | | |
| | | | | description | | | | |

The data sampling estimation unit 122 grabs Internet data to the Internet virtual resource library based on an interval sampling strategy or a point sampling strategy according to the data sampling guide tree and/or data sampling guide table. The data sampling estimation unit 122 samples and estimates the Internet Web data and/or the application programming interface of the internal database through sampling and analysis, and constructs an exploration sample library. The attribute information includes a data category, a data modality, a data amount, a data component and/or a data distribution, etc.

The data resource distribution map generation unit 123 generates the data resource distribution map according to the attribute information of the Internet Web data and access restriction in the data sampling guide tree.

FIG. 2B shows a schematic view of a data resource distribution map. As shown in FIG. 2A, the data resource distribution map includes initialization layer nodes and expansion layer nodes, and the initialization layer nodes and the expansion layer nodes form a tree structure. The initialization layer nodes include zeroth layer nodes (the zeroth layer nodes are root nodes), first layer nodes, and second layer nodes. The expansion layer nodes include third layer nodes (the third layer nodes are data nodes).

The zeroth layer nodes are classification nodes in the field of data, and description items of each node include data classification method, a data classification number, an access restriction, a first category pointer, a second category pointer . . . , an nth category pointer, and an extended item, etc., the data classification method is configured to record a data classification model or method, the category pointer is configured to point to a category node, and the extended item is configured to expand node information.

The first layer nodes are classification nodes of data modality, and description items of each of the first layer nodes include a number of a data modality, a limit command, a text pointer, an image pointer, a video pointer, an audio pointer, other pointers, and an extension item, etc. The data modality number refers to the classification number of data modalities, including five kinds of data: text, image, video, audio, and others. The text pointer, the image pointer, the video pointer, the audio pointer, and the other pointers are link pointers that record to a child node, and the child node is a node of a data modality.

Description items of each of the second layer nodes include a number of network sites, a limit command, a first site pointer, a second site pointer, . . . , an mth site pointer, and an extension item, etc. The number of network sites refers to a total number of network sites in a data modality and represents a number of child nodes of each of the second layer nodes. The site pointer is configured to record each child node.

The third layer nodes are data nodes, and description items of each of the third layer nodes include a data location, a limit command, a data amount, a data component, a data distribution, a data timing, an access command and parameter, a return data format, and an extension item, etc. The data location is configured to record a site location of a data source. The limit command is a limit access description for accessing the data source. The data amount is the amount of data from the data source provided by a data provider (it may also be empty). The data component represents a constituent element of data. The data distribution represents a basic characteristic and distribution of Internet data. The data timing represents whether there is a time series relationship between the Internet data. The access command and parameter record a command and a parameter for accessing the data source (it may also be empty). The return data format refers to a format of acquired data.

The Internet virtual resource library 13 includes a data resource distribution map and an exploration sample library. The data resource distribution map reflects the distribution information of Internet data, including information such as data location, data amount, data characteristics. The exploration sample library stores the sample data collected by the Internet data explorer.

The data resource distribution map management module 14 manages the data resource distribution map.

Specifically, the data resource distribution map management module 14 is configured to store, access, and update the data resource distribution map. The data resource distribution map is stored using a relational or non-relational database. The data resource distribution map is accessed according to a tree structure. The data resource distribution map is dynamically updated. The key to the data resource distribution map management in this embodiment is the dynamic update method of the data resource distribution map to ensure that the Internet virtual resource library is kept up-to-date.

The data resource guidance service module 15 generates and provides guidance service for data collection and mining of a data demander according to the data resource distribution map. The data resource guidance service module 15 can ensure that data users can efficiently and orderly collect and mine Internet data and further analysis.

The data security management module 16 performs data security management of a virtual data resource in the Internet virtual resource library 13. Specifically, the management of access to the virtual data resource includes management of data privacy protection and data access rights.

It should be noted that the division of each module of the above system is only a division of logical functions. In actual implementation, the modules may be integrated into one physical entity in whole or in part, or may be physically separated. And these modules may all be implemented in the form of processing component calling by software, or they may all be implemented in the form of hardware. It is also possible that some modules are implemented in the form of processing component calling by software, and some modules are implemented in the form of hardware. For example, an x module may be a separate processing component, or may be integrated in a chip of the above-mentioned system. In addition, the x module may also be stored in the memory of the above system in the form of program code. The function of the above x module is called and executed by a processing component of the above system. The implementation of other modules is similar. All or part of these modules may be integrated or implemented independently. The processing elements described herein may be an integrated circuit with signal processing capabilities. In the implementation process, each steps of the above method or each of the above modules may be completed by an integrated logic circuit of hardware in the processor component or an instruction in a form of software. The above modules may be one or more integrated circuits configured to implement the above method, such as one or more Application Specific Integrated Circuits (ASICs), one or more Digital Signal Processors (DSPs), or one or more Field Programmable Gate Arrays (FPGAs). When one of the above modules is implemented in the form of calling program codes by a processing component, the processing component may be a general processor, such as a Central Processing Unit (CPU) or other processors that may call program codes. These modules may be integrated and implemented in the form of a system-on-a-chip (SOC).

The new Internet virtual data center system of the present embodiment proposes the idea and technology of Internet big data exploration, realizes the virtualization of Internet big data resources, constructs the big data resource distribution map, and provides services such as data navigation for the data center. Different from the mass collection and storage of traditional data centers and cloudized data centers, the Internet virtual data center system in this embodiment changes the mass collection to pre-quantized exploration, which overcomes the blindness and disorder of the big data collection and development, and avoids a lot of waste of resources and energy.

### Embodiment 2

This embodiment provides a method for constructing a new Internet virtual data center system, including: constructing an Internet data explorer based on a data access protocol and Internet data provided by a data provider, the Internet data explorer is configured to sample and estimate the Internet data to generate a data resource distribution map; constructing an Internet virtual resource library according to Internet data explored by the Internet data explorer; the Internet virtual resource library is configured to store the data resource distribution map and sample data collected by the Internet data explorer; managing the Internet data explored by the Internet data explorer and the data resource distribution map; and generating and providing guidance service for data collection and mining of a data center and/or a data demander according to the data resource distribution map.

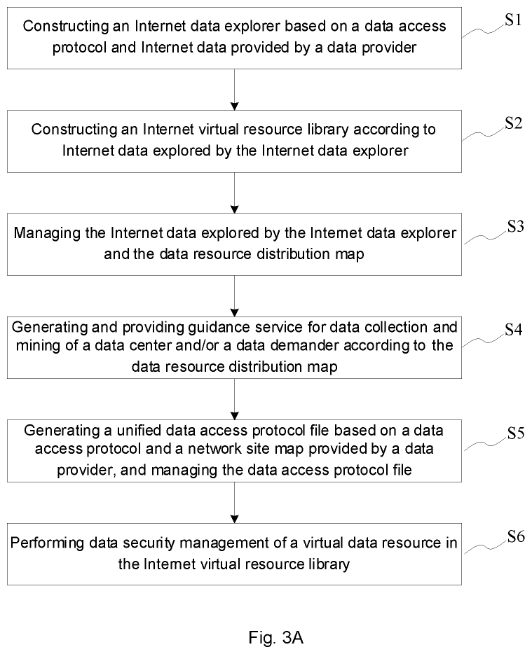

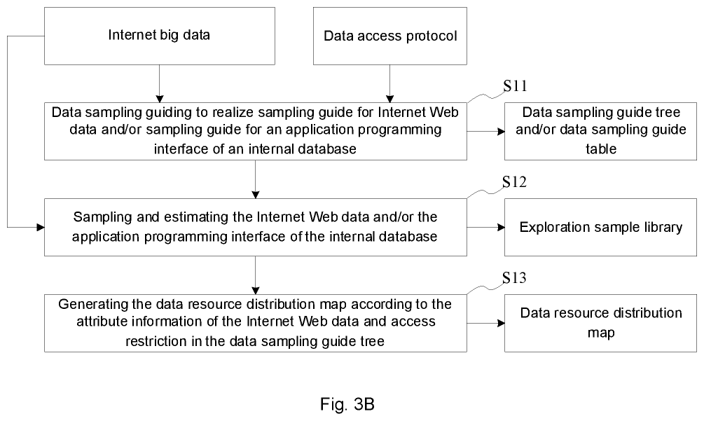

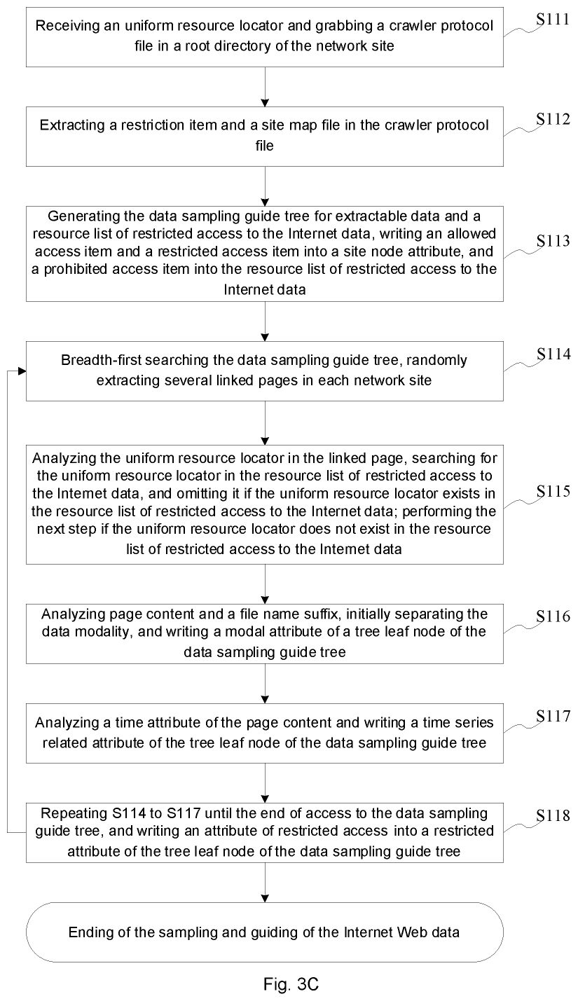

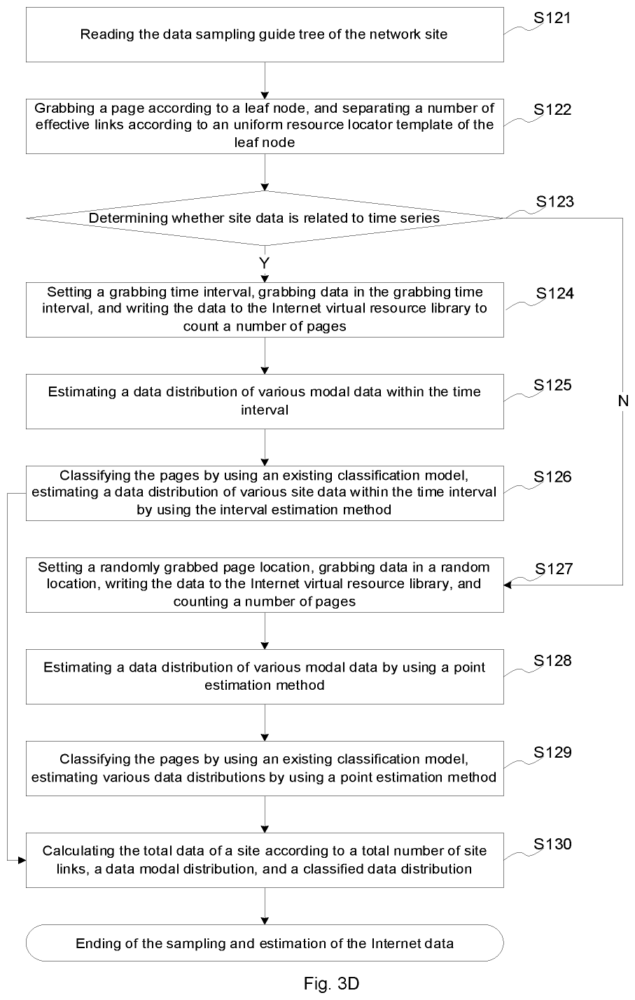

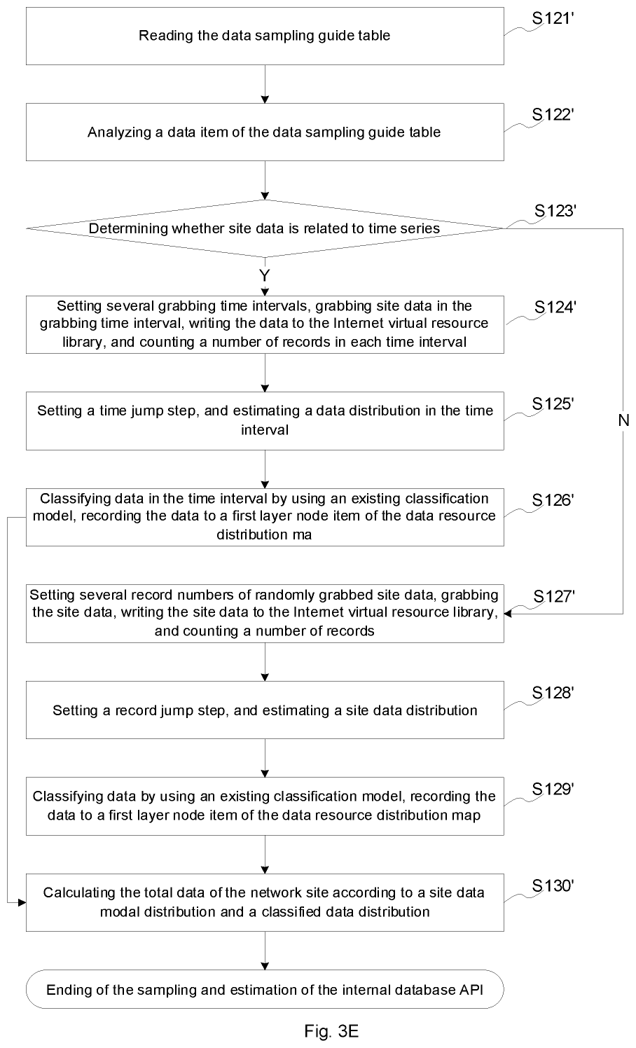

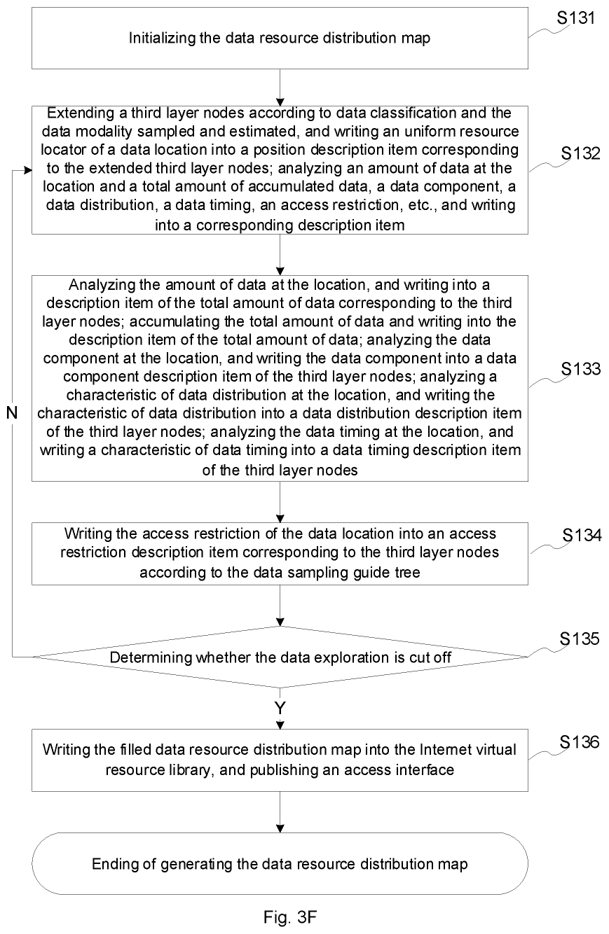

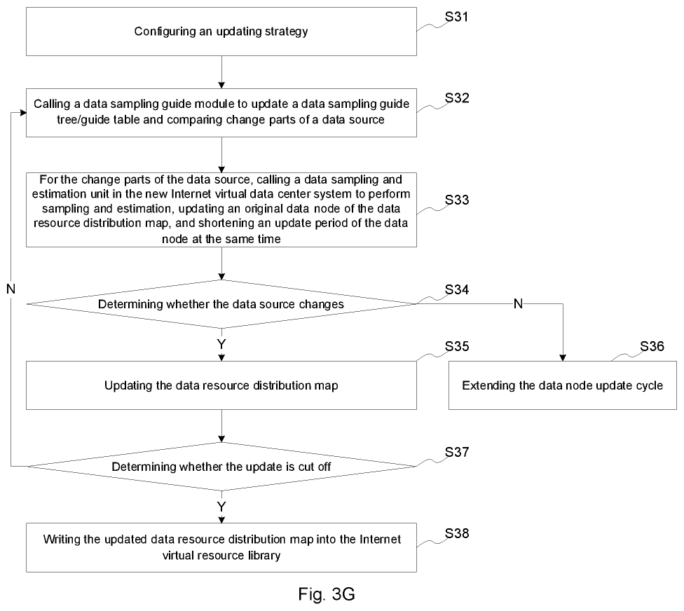

The method for constructing a new Internet virtual data center system in this embodiment will be described in detail below with reference to the drawings. FIG. 3A shows a schematic flow chart of a method for constructing a new Internet virtual data center system. As shown in FIG. 3A, the method for constructing the new Internet virtual data center system specifically includes the following steps:

S1: constructing an Internet data explorer based on a data access protocol and Internet data provided by a data provider, the Internet data explorer is configured to sample and estimate the Internet data to generate a data resource distribution map.

FIG. 3B shows a schematic flow chart of S1. As shown in FIG. 3B, the S1 specifically includes the following steps:

S11: generating data sampling guidance information according to a data access protocol file and Internet big data provided by a data provider, to realize sampling guide for Internet Web data and/or sampling guide for an application programming interface of an internal database, a data structure of the data sampling guidance information is represented as a data sampling guide tree and/or data sampling guide table, the data sampling guide tree is guide information for sampling the Internet data, the data sampling guide table is a data sampling guide information table that accesses the internal database of a network site through the application programming interface.

FIG. 3C shows a schematic flow chart of the sampling guide of Internet Web data. As shown in FIG. 3C, the guide process of the sampling guide of Internet Web data includes the following steps:

S111: receiving a uniform resource locator (URL) and grabbing a crawler protocol file robots.txt in a root directory of the network site.

S112: extracting a restriction item and a site map file sitemap.xml in the crawler protocol file robots.txt.

S113: generating the data sampling guide tree Web-GuideTree for extractable data and a resource list DisAllow-List of restricted access to the Internet data, as shown in FIG. 2A; writing an allowed access item Allow and a restricted access item Crawl-delay to a site node attribute, and a prohibited access item Disallow to the resource list DisAllow-List of restricted access to the Internet data. The resource list of restricted access to the Internet data is shown in Table 2.

TABLE 2
Resource list of restricted access to the Internet data DisAllow-List

| | | | |
|---|---|---|---|
| Resource | Data | Data explorer | Prohibited/ |
| location | type | name | Restricted item |

Disallow
Crawl-delay (restriction)

S114: breadth-first searching the data sampling guide tree Web-GuideTree, randomly extracting several linked pages in each network site.

S115: analyzing the URL in the linked page, searching for the URL in the resource list of restricted access to the Internet data, and omitting it if the URL exists in the resource list of restricted access to the Internet data; performing the next step if the URL does not exist in the resource list of restricted access to the Internet data.

S116: analyzing page content and a file name suffix, initially separating the data modality (such as text, image, video, audio, etc.), and writing a modal attribute of a tree leaf node of the data sampling guide tree Web-GuideTree.

S117: analyzing a time attribute of the page content and writing a time series related attribute of the tree leaf node of the data sampling guide tree Web-GuideTree.

S118: repeating S114 to S117 until the end of access to the data sampling guide tree Web-GuideTree, and writing an attribute of restricted access into a restricted attribute of the tree leaf node of the data sampling guide tree Web-GuideTree, the Internet web data sampling guide ends.

In this embodiment, the guiding process of the sampling guide for the application programming interface of the internal database includes: determining whether an access configuration file of the application programming interface of the internal database of a designated network site can be grabbed within the designated network site, if the access configuration file can not be grabbed within the designated network site, instructing an operator to manually generate the access configuration file of the application programming interface of the internal database, if there is no such access configuration file, and the web site does not provide API access, the process ends; if the access configuration file can be grabbed within the designated network site, performing the next step; and analyzing the access configuration file of the application programming interface of the internal database, initially separating the data modality, and filling a data sampling guide information table of the internal database.

S12: Grabbing Internet data to the Internet virtual resource library according to the data sampling guide tree and/or data sampling guide table, sampling and estimating the Internet Web data and/or the application programming interface of the internal database through sampling and analysis, and constructing an exploration sample library. The attribute information includes a data category, a data modality, a data amount, a data component and/or a data distribution.

FIG. 3D shows a schematic flow chart of the estimation process of sampling and estimation of the Internet Web data. As shown in FIG. 3D, the estimation process of the sampling and estimation of Internet Web data includes the following steps:

S121: reading the data sampling guide tree of the network site Web-GuideTree.

S122: grabbing a page according to a leaf node, and separating a number of effective links according to a uniform resource locator URL template of the leaf node.

S123: determining whether site data is related to time series, if the site data is related to the time series, executing S124, setting a grabbing time interval, grabbing data in the grabbing time interval, writing the data to the Internet virtual resource library, and counting a number of pages Page-Count.

S125: estimating a data distribution of various modal data within the time interval by using an interval estimation method.

S126: classifying the pages by using an existing classification model, estimating a data distribution DataModalRate of various site data within the time interval by using the interval estimation method, then turning to S130.

If the site data is not related to the time series, executing S127: setting a randomly grabbed page location, grabbing data in a random location, writing the data to the Internet virtual resource library, and counting a number of pages DataModalRate.

S128: estimating a data distribution of various modal data by using a point estimation method.

S129: classifying the pages by using an existing classification model, estimating various data distributions by using a point estimation method, then turning to S130.

S130: calculating the total data amount of a site according to a total number of site links, a data modal distribution, and a classified data distribution, and the Internet data sampling and estimation ends.

FIG. 3E shows a schematic flow chart of the estimation process of the sampling and estimation for the application programming interface of the internal database. As shown in FIG. 3E, the estimation process of the sampling and estimation for the application programming interface of the internal database specifically includes the following steps:

S121′: reading the data sampling guide table API-GuideList.

S122′: analyzing a data item of the data sampling guide table API-GuideList.

S123′: determining whether site data is related to time series.

If the site data is related to the time series, executing S124′, setting several grabbing time intervals, grabbing site data in the grabbing time interval, writing the data into the Internet virtual resource library, and counting a number of records in each time interval.

S125′: setting a time jump step, and estimating a data distribution DataModalRate in the time interval.

S126′: classifying data in the time interval by using an existing classification model, recording the data to a first layer node item of the data resource distribution map, then turning to S130′.

If the site data is not related to the time series, executing S127′: setting several record numbers of randomly grabbed site data, grabbing the site data, writing the site data into the Internet virtual resource library, and counting a number of records.

S128′, setting a record jump step, and estimating a site data distribution DataModalRate.

S129′: classifying data by using an existing classification model, recording the data to a first layer node item of the data resource distribution map.

S130′: calculating the total data amount of the network site according to a site data modal distribution and a classified data distribution, and the sampling and estimation of the internal database API ends.

S13: Generating the data resource distribution map according to the attribute information of the Internet Web data and access restriction in the data sampling guide tree.

FIG. 3F shows a schematic flow chart of S13. As shown in FIG. 3F, the S13 specifically includes the following steps:

S131: initializing the data resource distribution map, S131 includes: constructing root nodes, constructing first layer nodes, which are classification nodes (for example, e-commerce, education, etc.), and constructing second layer nodes, which are data modal nodes (for example, text, image, video, audio, etc.).

S132: extending third layer nodes according to data classification and the data modality sampled and estimated, and writing a uniform resource locator of a data location into a position description item corresponding to the extended third layer nodes; analyzing an amount of data at the location and a total amount of accumulated data, a data component, a data distribution, a data timing, an access restriction, etc., writing a corresponding description item to analyze the amount of data at the location, and writing into a corresponding description item.

S133: analyzing the amount of data at the location, and writing into a description item of the total amount of data corresponding to the third layer nodes; accumulating the total amount of data and writing into the description item of the total amount of data; analyzing the data component at the location, and writing the data component into a data component description item of the third layer nodes; analyzing a characteristic of data distribution at the location, and writing the characteristic of data distribution into a data distribution description item of the third layer nodes; analyzing the data timing at the location, and writing a characteristic of data timing into a data timing description item of the third layer nodes.

S134: writing the access restriction of the data location into an access restriction description item corresponding to the third layer nodes according to the data sampling guide tree Web-GuideTree.

S135: determining whether the data exploration is cut off; if the data exploration is cut off, executing S136: writing the filled data resource distribution map into the Internet virtual resource library, and publishing an access interface, the step of generating the data resource distribution map ends; if the data exploration is not cut off, returning to S132: extending the third layer nodes according to the data classification and the data modality sampled and estimated, and writing the uniform resource locator of the data location into the position description item corresponding to the extended third layer nodes; analyzing an amount of data at the location and a total amount of accumulated data, a data component, a data distribution, a data timing, an access restriction, etc., writing a corresponding description item to analyze the amount of data at the location, and writing into a corresponding description item.

S2: Constructing an Internet virtual resource library according to Internet data explored by the Internet data explorer; the Internet virtual resource library is configured to store the data resource distribution map and sample data collected by the Internet data explorer.

S3: Managing the Internet data explored by the Internet data explorer and the data resource distribution map.

Specifically, the managing of the Internet data explored by the Internet data explorer and the data resource distribution map includes: storing, accessing, and updating the data resource distribution map.

FIG. 3G shows a schematic flow chart of updating the data resource distribution map. As shown in FIG. 3G, the step of updating the data resource distribution map specifically includes the following steps:

S31: configuring an updating strategy; in this embodiment, the updating strategy includes partial/full update, node update cycle, etc.

S32: calling a data sampling guide module to update a data sampling guide tree/guide table and comparing change parts of a data source.

S33: for the change parts of the data source, calling a data sampling and estimation unit in the new Internet virtual data center system to perform sampling and estimation, updating an original data node of the data resource distribution map, and shortening an update period of the data node at the same time.

S34: for the change parts of the data source, randomly selecting the data source, and calling the data sampling and estimation unit to perform sampling and estimation, to determine whether the data source changes; if the data source changes, executing S35: updating the data resource distribution map, then turning to S37; if the data source does not change, executing S36: extending the data node update cycle, then turning to S37.

S37: determining whether the update is cut off, if the update is cut off, executing S38: writing the updated data resource distribution map into the Internet virtual resource library; if the update is not cut off, returning to S32: calling the data sampling guide module to update the data sampling guide tree/guide table and comparing the change parts of the data source.

S4: Generating and providing guidance service for a data collection and mining of a data center and/or a data demander according to the data resource distribution map.

S5: Generating a unified data access protocol file based on a data access protocol and a network site map provided by a data provider, and managing the data access protocol file. In this embodiment, the data access protocol file includes a Web data access protocol, an Internet internal database access protocol, etc. The management of the data access protocol file includes issuing and updating the protocol.

S6: Performing data security management of a virtual data resource in the Internet data explorer.

For example, the management of access to the virtual data resource includes management of data privacy protection and data access rights.

The present disclosure provides a new Internet virtual data center system. The new Internet virtual data center system may implement the method for constructing a new Internet virtual data center system as described in the present disclosure. However, the realizing device of the method for constructing a new Internet virtual data center system as described in the present disclosure is not limited to the structure of the new Internet virtual data center system as listed in this embodiment. Any structural deformation and replacement of existing techniques made according to the principle of the present disclosure are included in the protection scope of the present disclosure.

The present disclosure further provides a method for constructing a new Internet virtual data center system. The protection scope of the method for constructing a new Internet virtual data center system as described in the present disclosure is not limited to the sequence of steps listed in this embodiment. Any solution realized by adding or subtracting steps or replacing steps of the existing techniques according to the principle of the present disclosure is included in the protection scope of the present disclosure.

In summary, the new Internet virtual data center system, the method for constructing the same, the readable storage medium and terminal of the present disclosure propose the idea and technology of Internet big data exploration, realize the virtualization of Internet big data resources, construct the big data resource distribution map, and provide services such as data navigation for the data center. Different from the mass collection and storage of traditional data centers and cloudized data centers, the Internet virtual data center system in this embodiment changes the mass collection to pre-quantized exploration, which overcomes the blindness and disorder of the big data collection and development, and avoids a lot of waste of resources and energy. The present disclosure effectively overcomes various shortcomings and has high industrial utilization value.

The above-mentioned embodiments are just used for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

We claim:

1. A new Internet virtual data center system, comprising:
an Internet data explorer to sample and estimate Internet data to generate a data resource distribution map, the data resource distribution map reflects attribute information of Internet data;
an Internet virtual resource library to store the data resource distribution map and sample data collected by the Internet data explorer;
a data resource distribution map management module to manage the data resource distribution map; and
a data resource guidance service module to generate and provide guidance service for a data collection and mining of a data demander according to the data resource distribution map.

2. The new Internet virtual data center system according to claim 1, further comprising:
a data protocol generation and management module to generate a unified data access protocol file based on a data access protocol and a network site map provided by a data provider, and manage the data access protocol file;
a data security management module to perform data security management of a virtual data resource in the Internet virtual resource library.

3. The new Internet virtual data center system according to claim 1, wherein the Internet data explorer comprises:
a data sampling guide unit to generate data sampling guidance information according to a data access protocol file provided by a data provider, to realize sampling guide for Internet Web data and/or sampling guide for an application programming interface of an internal database, a data structure of the data sampling guidance information is a data sampling guide tree and/or data sampling guide table, the data sampling guide tree is guide information for sampling the Internet Web data, the data sampling guide table accesses the internal database of a network site through the application programming interface;
a data sampling estimation unit to sample and grab Internet data to the Internet virtual resource library according to the data sampling guide tree and/or data sampling guide table, and to sample and estimate the Internet Web data and/or the application programming interface of the internal database, the attribute information includes a data category, a data modality, a data amount, a data component, and a data distribution; and
a data resource distribution map generation unit to generate the data resource distribution map according to the attribute information of the Internet Web data and access restriction in the data sampling guide tree and/or data sampling guide table.

4. The new Internet virtual data center system according to claim 3, wherein the data resource distribution map comprises initialization layer nodes and expansion layer nodes, and the initialization layer nodes and the expansion layer nodes form a tree structure, the initialization layer nodes include zeroth layer nodes, first layer nodes, and second layer nodes, the expansion layer nodes include third layer nodes, wherein
the zeroth layer nodes are root nodes of the data resource distribution map, and description items of the zeroth layer nodes include a data classification method, a data classification number, an access restriction, a first category pointer, a second category pointer . . . , an nth category pointer, and an extended item, wherein the data classification method is configured to record a data classification model or method; the category pointer is configured to point to a category node, and the extended item is configured to expand node information;
the first layer nodes are classification nodes of data field, and description items of each of the first layer nodes include a data modal number, a limit command, a text pointer, an image pointer, a video pointer, an audio pointer, other pointers, and an extension item, wherein the data modal number refers to a classification number of a data modality, including text, image, video, and audio, and the text pointer, the image pointer, the video pointer, the audio pointer, and the other pointers are link pointers that record to a child node, and the child node is a node of a data modality;
the second layer nodes are data modal classification nodes, and description items of each of the second layer nodes include a number of network sites, a limit command, a first site pointer, a second site pointer, . . . , an mth site pointer, and an extension item, wherein the number of network sites refers to a total number of network sites in a data modality and represents a number of child nodes of each of the second layer nodes, and the site pointer is configured to record each child node; and
the third layer nodes are data nodes, and description items of each of the third layer nodes include a data location, a limit command, a data amount, a data component, a data distribution, a data timing, an access command and parameter, a return data format, and an extension item, wherein the data location is configured to record a site location of a data source, the limit command is a limit access description for accessing the data source, the data amount is the amount of data from the data source provided by a data provider, the data component represents a constituent element of data, the data distribution represents a basic characteristic and distribution of Internet data, the data timing represents whether there is a time series relationship between the Internet data, the access command and parameter record a command and a parameter for accessing the data source, and the return data format refers to a format of acquired data.

5. The new Internet virtual data center system according to claim 1, wherein the data resource distribution map management module is configured to store, access, and update the data resource distribution map, wherein the data resource distribution map is stored using a relational or non-relational database; the data resource distribution map is accessed according to a tree structure; and the data resource distribution map is dynamically updated.

6. A method for constructing a new Internet virtual data center system, comprising:
constructing an Internet data explorer based on a data access protocol and Internet data provided by a data provider, the Internet data explorer is configured to sample and estimate the Internet data to generate a data resource distribution map;
constructing an Internet virtual resource library according to Internet data explored by the Internet data explorer; the Internet virtual resource library is configured to store the data resource distribution map and sample data collected by the Internet data explorer;
managing the Internet data explored by the Internet data explorer and the data resource distribution map; and
generating and providing guidance service for data collection and mining of a data center and/or a data demander according to the data resource distribution map.

7. The method for constructing a new Internet virtual data center system according to claim 6, further comprising:
generating a unified data access protocol file based on a data access protocol and a network site map provided by a data provider, and managing the data access protocol file; and
performing data security management of a virtual data resource in the Internet virtual resource library.

8. The method for constructing a new Internet virtual data center system according to claim 6, wherein
said constructing of the Internet data explorer based on the data access protocol and Internet data provided by the data provider comprising the following steps:
S11: generating data sampling guidance information according to a data access protocol file provided by a data provider, to realize sampling guide for Internet Web data and/or sampling guide for an application programming interface of an internal database, wherein a data structure of the data sampling guidance information is a data sampling guide tree and/or data sampling guide table, the data sampling guide tree is guide information for sampling the Internet Web data, the data sampling guide table accesses the internal database of a network site through the application programming interface;
S12: sampling and grabbing Internet data to the Internet virtual resource library according to the data sampling guide tree and/or data sampling guide table, sampling and estimating the Internet Web data and/or the application programming interface of the internal database, the attribute information includes a data category, a data modality, a data amount, a data component, and a data distribution; and
S13: generating the data resource distribution map according to the attribute information of the Internet Web data and access restriction in the data sampling guide tree.

9. The method for constructing a new Internet virtual data center system according to claim 8, wherein a guide process of the sampling guide for the Internet Web data comprises the following steps:
S111: receiving a uniform resource locator and grabbing a crawler protocol file in a root directory of the network site;
S112: extracting a restriction item and a site map file in the crawler protocol file;
S113: generating the data sampling guide tree for extractable data and a resource list of restricted access to the Internet data; writing an allowed access item and a restricted access item into a site node attribute, and a prohibited access item into the resource list of restricted access to the Internet data;
S114: breadth-first searching the data sampling guide tree, randomly extracting several linked pages in each network site;
S115: analyzing the uniform resource locator in the linked page, searching for the uniform resource locator in the resource list of restricted access to the Internet data, and omitting it if the uniform resource locator exists in the resource list of restricted access to the Internet data; performing the next step if the uniform resource locator does not exist in the resource list of restricted access to the Internet data;
S116: analyzing page content and a file name suffix, initially separating the data modality, and writing a modal attribute of a tree leaf node of the data sampling guide tree;
S117: analyzing a time attribute of the page content and writing a time series related attribute of the tree leaf node of the data sampling guide tree;
S118: repeating S114 to S117 until the end of access to the data sampling guide tree, and writing an attribute of restricted access into a restricted attribute of the tree leaf node of the data sampling guide tree.

10. The method for constructing a new Internet virtual data center system according to claim 8, wherein a guide process of the sampling guide for the application programming interface of the internal database comprises:
determining whether an access configuration file of the application programming interface of the internal database of a designated network site can be grabbed within the designated network site, if the access configuration file can not be grabbed within the designated network site, instructing an operator to manually generate the access configuration file of the application programming interface of the internal database, if the access configuration file can be grabbed within the designated network site, performing the next step; and
analyzing the access configuration file of the application programming interface of the internal database, initially separating the data modality, and filling a data sampling guide information table of the internal database.

11. The method for constructing a new Internet virtual data center system according to claim 8, wherein an estimation process of the sampling and estimation of the Internet Web data comprises the following steps:
S121: reading the data sampling guide tree of the network site;
S122: grabbing a page according to a leaf node, and separating a number of effective links according to a uniform resource locator template of the leaf node;
S123: determining whether site data is related to time series,
if the site data is related to the time series, executing S124, setting a grabbing time interval, grabbing data in the grabbing time interval, and writing the data into the Internet virtual resource library to count a number of pages;
S125: estimating a data distribution of various modal data within the time interval by using an interval estimation method;
S126: classifying the pages by using an existing classification model, estimating a data distribution of various site data within the time interval by using the interval estimation method, then turning to S130;
if the site data is not related to the time series, executing S127: setting a randomly grabbed page location, grabbing data in a random location, writing the data into the Internet virtual resource library, and counting a number of pages;
S128: estimating a data distribution of various modal data by using a point estimation method;
S129: classifying the pages by using an existing classification model, estimating various data distributions by using a point estimation method, then turning to S130;
S130: calculating the total data of a site according to a total number of site links, a data modal distribution, and a classified data distribution, and the sampling and estimation ends.

12. The method for constructing a new Internet virtual data center system according to claim 8, wherein an estimation process of the sampling and estimation for the application programming interface of the internal database comprises the following steps:
S121′: reading the data sampling guide table;
S122′: analyzing a data item of the data sampling guide table;
S123′: determining whether site data is related to time series,
if the site data is related to the time series, executing S124′, setting several grabbing time intervals, grabbing site data in the grabbing time interval, writing the data into the Internet virtual resource library, and counting a number of records in each time interval;
S125′: setting a time jump step, and estimating a data distribution in the time interval;
S126′: classifying data in the time interval by using an existing classification model, recording the data to a first layer node item of the data resource distribution map, then turning to S130′;
if the site data is not related to the time series, executing S127′: setting several record numbers of randomly grabbed site data, grabbing the site data, writing the site data into the Internet virtual resource library, and counting a number of records;
S128′, setting a record jump step, and estimating a site data distribution;
S129′: classifying data by using an existing classification model, recording the data to a first layer node item of the data resource distribution map; and S130′: calculating the total data of the network site according to a site data modal distribution and a classified data distribution.

13. The method for constructing a new Internet virtual data center system according to claim 8, wherein said generating of the data resource distribution map according to the attribute information of the Internet Web data and access restriction in the data sampling guide tree comprises:
initializing the data resource distribution map, which includes: constructing root nodes, constructing first layer nodes, and constructing second layer nodes;
extending third layer nodes according to data classification and the data modality sampled and estimated by data, and writing a uniform resource locator of a data location into a position description item corresponding to the extended third layer nodes; analyzing an amount of data at the location and a total amount of accumulated data, a data component, a data distribution, a data timing, an access restriction, etc., writing a corresponding description item to analyze the amount of data at the location, and writing into a description item of the total amount of data corresponding to the third layer nodes; accumulating the total amount of data and writing into the description item of the total amount of data;
analyzing the data component at the location, and writing the data component into a data component description item of the third layer nodes;
analyzing a characteristic of data distribution at the location, and writing the characteristic of data distribution into a data distribution description item of the third layer nodes;
analyzing the data timing at the location, and writing a characteristic of data timing into a data timing description item of the third layer nodes;
writing the access restriction of the data location into an access restriction description item corresponding to the third layer nodes according to the data sampling guide tree; and
determining whether the data exploration is cut off; if the data exploration is cut off, writing the filled data resource distribution map to the Internet virtual resource library, and publishing an access interface to outside, the step of generating the data resource distribution map ends; if the data exploration is not cut off, extending the third layer nodes according to the data classification and the data modality sampled and estimated by the data, and writing the uniform resource locator of the data location into the position description item corresponding to the extended third layer nodes; analyzing an amount of data at the location and a total amount of accumulated data, a data component, a data distribution, a data timing, an access restriction, writing a corresponding description item to analyze the amount of data at the location, and writing into a corresponding description item.

14. The method for constructing a new Internet virtual data center system according to claim 6, wherein said managing of the Internet data explored by the Internet data explorer and the data resource distribution map comprises: storing, accessing, and updating the data resource distribution map.

15. The method for constructing a new Internet virtual data center system according to claim 6, wherein said updating of the data resource distribution map comprises:
configuring an updating strategy;
calling a data sampling guide module to update a data sampling guide tree/guide table and comparing change parts of a data source;
for the change parts of the data source, calling a data sampling and estimation unit in the new Internet virtual data center system to perform sampling and estimation, updating an original data node of the data resource distribution map, and shortening an update period of the data node at the same time;
for the change parts of the data source, randomly selecting the data source, and calling the data sampling and estimation unit to perform sampling and estimation, to determine whether the data source changes; if the data source changes, updating the data resource distribution map; if the data source does not change, extending the update period of the data node;
determining whether the update is cut off, if the update is cut off, writing the updated data resource distribution map to the Internet virtual resource library; if the update is not cut off, calling the data sampling guide module to update the data sampling guide tree/guide table and comparing the change parts of the data source.
